(19) United States
(12) Patent Application Publication
(10) Pub. No.: US 2022/0212940 A1
(43) Pub. Date: Jul. 7, 2022

(54) SYNTHESIS OF ADSORPTION MATERIALS

(71) Applicant: Zeotech Limited, Perth (AU)

(72) Inventors: James Vaughan, Indooroopilly (AU); Hong Peng, Middle Park (AU)

(73) Assignee: Zeotech Limited, Perth (AU)

(21) Appl. No.: 17/606,994

(22) PCT Filed: May 8, 2020
(86) PCT No.: PCT/AU2020/050457

§ 371 Date: Oct. 27, 2021

(30) Foreign Application Priority Data
Jun. 5, 2019 (AU) 2019901952

(51) Int. Cl. C01B 39/18; C22B 3/44; C22B 3/12

(52) U.S. Cl. CPC C01B 39/18; C22B 3/12; C22B 3/44

(57) ABSTRACT

A process for producing zeolites comprising: a) calcining a clay material to form an amorphous material from clay components in the clay material, b) leaching the material from step (a) in a leaching solution to produce a solution containing dissolved aluminium and dissolved silica and a solid residue, c) separating the solid residue from the solution, and d) crystallising zeolites from the solution from step (c).

### TECHNICAL FIELD

The present invention relates to a method for producing absorbents. More particularly, the present invention relates to a method for producing zeolites.

### BACKGROUND ART

Zeolites are microporous aluminosilicate materials. They have found widespread commercial use as adsorbents and catalysts. Zeolites that are used on a commercial scale are synthesised in industrial processes to ensure that the desired purity of the zeolite for use in the commercial process is achieved. In this regard, although zeolites do occur in nature, natural zeolites are usually found with impurity elements and minerals, thereby rendering them less useful for commercial use.

Industrial manufacture of zeolites at present involves forming solutions of aluminium and silicate and mixing those solutions together under conditions that result in precipitation of the zeolites. To give one example, a sodium aluminate solution is mixed with a sodium silicate solution at an alkaline pH (arising from the aluminate in the solution) under stirring and with the presence of seed particles and/or templating agents at a temperature of around 90° C. This results in precipitation of the zeolites.

Zeolites are crystalline microporous aluminosilicates that have three dimensional frameworks made of SiO₄ and AlO₄. The zeolites contain cages of molecular dimensions which can have large central pores formed by rings of different diameters. Due to the zeolites' microporous properties, they have many applications within various fields such as in laundry detergents, ion exchange and water treatment. There are also many different zeolites which can exist naturally or can be synthesised, synthetic zeolites are more expensive, but they have a much wider range of applications than natural zeolites. One of the main research topics is the zeolites' ability to adsorb metal cations to remove them from waste water streams due to their net negative charge, high porosity and potential low cost. Most reports relating to this issue focus on the zeolite LTA (also called Zeolite 4A due to pore size, 4 Å, the two terms will be used interchangeably in this specification). Zeolite 4A has been synthesised from coal fly ash (CFA), which showed very similar maximum adsorption capacities with a difference of 3 mg/g for Cu²¹ (50.45 and 53.45 mg/g for CFA and commercial, respectively). Coal fly ash synthesised zeolite A (LTA), showed greater removal efficiency compared to zeolite X synthesised from coal fly ash which achieved 47 and 83 mg/g adsorption capacity for Cu²⁺ and Zn²⁺. The highest adsorption capacity achieved was using 0.5 g LTA which is extremely small when comparing to the capacities of other synthetic zeolites or even against some of the natural zeolite materials.

In general, as shown in FIG. 1, synthesis of zeolites from kaolinite-containing minerals need two main steps: (i) amorphorization—which means transforming kaolinite into an amorphous solid (metakaolin) by thermal activation (>500° C.), and (ii) zeolitization—dissolving the amorphous solids with caustic solution to synthesis zeolite. For the amorphous transition step, the temperature and time in the thermal activation process are the key process parameters. Studies have been carried out by different groups on the amorphous transition of kaolinite with different views. Chandrasekhar investigated the influence of metakaolinization temperature on the formation of zeolite 4A from kaolinite. The results showed that a calcination temperature of 900° C. with one hour heating time is the optimum for this clay to change into a reactive metakaolin. Later on, research reported that temperatures of 600-700° C. are the optimal range. For the zeolitization step, there are several sub-steps to accomplish the hydrothermal synthesis including formation of a slurry gel, heating the slurry gel to form zeolite crystals and calcining the crystal zeolites to remove organic templates if organic templates were added into solution for phase and morphology control. The process of zeolitization is complex and affected by many factors such as silicate to aluminate ratio, starting materials, organic templates, aging conditions, crystallization time and temperatures, and alkalinity, as shown in equations 1 and 2.

Most kaolin ore deposits contain a significant amount of other mineral impurities, especially quartz, feldspar and muscovite. These impurities often affect the quality of the clay and its final properties of the zeolite for adsorption. To minimize the impurities, kaolin needs to be purified for synthesis of zeolites. In the purification steps in known processes, mechanical separation to separate the coarse fraction could to be used to remove part of the impurities which will increase the technical complexity of the process and the remainder of the impurities will still remain with the clay. Only a few studies considered the removal of impurities, but generally, the impurities are allowed to enter the final zeolite products.

Al₂O.2SiO₂.2H₂O(kaolin/metakaolin)+6OH⁻+6H₂O→2Al(OH)₄⁻+2H₂SiO₄²⁻ (1)

8Na⁺+6Al(OH)₄⁻+6H₂SiO₄²⁻=Na₆(AlSiO₄)₆(NaOH)₂.2H₂O(DSPs)+10H₂O++10OH⁻ (2)

With the advances associated with industrial development since the 20^{th} century, the consumption of primary metal and coal has significantly increased over the last hundred years. The accumulation of the mining tailings has caused serious environmental and financial burdens for industry and government due to land occupation as well as soil and water contamination. The disposal or utilisation or remediation of these mining tailings has become an urgent issue. Recently, many research studies have been conducted on these mining tailings to exploit them as a potential materials or feeds for recovery the valuable components. Most mining tailings contain significant amount of clay materials, for example, kaolin minerals, which is an abundant source of Si and Al. Kaolinite, Al₂[Si₂O₅](OH)₄, is the main phase of the kaolin group of clay minerals. It is formed when anhydrous aluminosilicate found in feldspar rich rock is altered by weathering or hydrothermal processes. The kaolinite crystal structure is composed of a plane of SiO₄ tetrahedra linked by oxygen atoms parallel to a plane of AlO₂(OH)₄ octahedra.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a process for producing zeolites, which may at least partially overcome at least one of the abovementioned disadvantages or provide the consumer with a useful or commercial choice.

With the foregoing in view, the present invention in one form, resides broadly in a process for producing zeolites comprising:

a) calcining a clay-containing material to form an amorphous material from clay components in the clay material,
b) leaching the material from step (a) in a leaching solution at 70° C. or less to produce a solution containing dissolved aluminium and dissolved silica and a solid residue,
c) separating the solid residue from the solution, and
d) crystallising zeolites from the solution from step (c).

The process of the present invention utilises clay-containing materials as a feed for use in the production of zeolites. Clay materials are widespread, readily available and inexpensive. Clay materials are also widely found in mining tailings and overburden removed from mining operations. These sources promise to provide large quantities of inexpensive feed material for the present process whilst also adding value to what would otherwise be problematic waste materials.

Most clay materials include hydrated silicates of aluminium with impurities that can typically include quartzite, feldspar, muscovite, metal oxides and organic matter. A large variety of clay materials can be used in the present invention. Kaolin clays are especially suitable. Types of clays that can be used in the present invention include kaolinite (wAl₄Si₄O₁₀(OH)₈), halloysite (Al₂Si₂O₅(OH)₄) and montmorillonite (Al₄(Si₄O₁₀)₂(OH)₄*xH₂O)). Other materials that include kaolinite, halloysite or montmorillonite phases and can be used in the present invention include mining tailings, such as mining tailings from kaolin mining, coal gangue kaolin, bentonite clays and bauxite mine or flotation tailings, coal flotation tailings and bauxite.

The calcination step is used to convert the clay components of the clay material to an amorphous material. In one embodiment, the calcination step includes characterising phase transformation of the clay material using in-situ high temperature XRD (x-ray diffraction). In one embodiment, one or more samples of clay material were subject to programmed heating rate and time and in-situ XRD was used to obtain the XRD phase transformation pattern of the clay material. After obtaining the full XRD phase transformation pattern, the optimum calcination temperature and calcination time was determined to instruct the large scale calcination of clay material using conventional calcination equipment (such as a furnace). This can avoid overheating of the clay material in the calcination step and can favourably minimise the energy costs required in the calcination step.

In another embodiment, the calcination step involves heating the clay material to a pre-determined temperature for a pre-determined period of time. In some embodiments, the present invention encompasses any calcination step, suitably any calcination step that converts most or all of the clay material to an amorphous material.

The temperatures used in the calcination step may vary between 600° C. to 900° C. The time at which the clay material is heated in the calcination step can vary in accordance with the temperature, with higher temperatures requiring less time for calcination. It should be mentioned both temperature and time may change with different minerals mineralogy and calcination equipment efficiency.

In one embodiment, the clay material is placed in a furnace in the calcination step with the furnace being heated to a temperature of from 600° C. to 900° C., or from 625° C. to 800° C., or from 650° C. to 750° C.

In some embodiments, the clay material is subject to heating in the calcination step for a period of from 1 minute to 2 hours. As mentioned above, the higher the temperature used in the calcination step, the lower the time that is required to achieve conversion of clay material to the amorphous phase. In one embodiment, the heating time used in the calcination step is from 5 minutes to 1.5 hours, or from 8 minutes to 1.5 hours. Some times and temperatures that may be suitable for the calcination of kaolin materials include:

650° C. for 1.5 hours
700° C. for 0.5 hours
750° C. for 8 minutes.

In the calcination step, the clay materials undergo a dehydroxylation process and are converted to an amorphous material. If a kaolin clay material is used in the calcination step, the kaolinite is converted to metakaolin in the calcination step.

It has been found that impurity materials in the clay material supplied to the calcination step are typically not affected by the calcination step. For example, impurity quartz, muscovite and feldspar remain essentially unchanged in the calcination step. In some embodiments, the calcination step is conducted at a temperature below that at which quartz, feldspar or muscovite undergo a phase transformation.

Following the calcination step, the amorphous material is removed from the furnace. In some embodiments, the amorphous material is allowed to cool at least down to a temperature that is equivalent to the temperature at which the leaching step is carried out. In other embodiments, the amorphous material is removed from the furnace and placed in transport and/or storage so that it can be subjected to leaching at a different venue or at a later stage.

In the leaching step, the amorphous material recovered from the calcination step is leached in a leaching solution. This dissolves the aluminium components and the silicate components from the amorphous material. However, impurity components that were present in the amorphous material do not dissolve and remain as a solid residue. It will be appreciated that the undissolved solid residue in the leaching step is in the form of particulate material. The leaching step is generally conducted with agitation in order to ensure adequate mixing between the solid material and the leach solution, which improves leaching kinetics.

In one embodiment, the leaching solution comprises an alkaline solution. The alkaline solution suitably comprises sodium hydroxide solution, although other hydroxide solutions such as KOH may also be used. Sodium hydroxide is widely available and relatively inexpensive so it is preferred for use in the leaching step.

In one embodiment, the alkaline solution comprises a hydroxide solution having a molar content of hydroxide ions of at least 1M, or from 1M to 6M, or from 1M to 5M, or from 1M to 4M or from 2M to 6M. In experimental work conducted by the present inventors, a sodium hydroxide solution having a concentration of 4M was used as the leaching solution.

The leaching step may be conducted at a temperature at which precipitation of crystallisation of zeolites or other desilication products (DSPs) is suppressed or minimised. In this regard, solutions containing dissolved aluminium and dissolved silica or dissolved silicates are metastable and will tend to have solids precipitate therefrom. Such solutions tend to become less stable at higher temperatures. In the leaching step, the undissolved solid residue, which comprises undissolved impurity particles, is mixed with the leaching solution. Accordingly, if there is any precipitation of zeolites or DSPs in the leaching step, that will tend to occur on the undissolved impurity particles. This material will need to be separated from the solution and may be discarded. Accordingly, precipitation of zeolites or DSPs in the leaching step represents a loss of yield and should be avoided. The DSPs that may otherwise precipitate could include other zeolite phases, such as amorphous zeolites, sodalite, zeolite LTN or cancrinite.

In one embodiment, the temperature used in the leaching step is 70° C. or less, or from 50° C. to 70° C. It has been found that at temperatures of from 50° C. to 70° C., leaching occurs at a sufficiently high rate to be useful and that precipitation of zeolites or DSPs can be avoided by controlling the time at which the leaching is conducted. For example, if the leaching is conducted for less than 1 hour, such as for 5 minutes to 1 hour, or from 10 minutes to 30 minutes, or from 15 minutes to 30 minutes, most of the aluminium and silica in the amorphous material will dissolve whilst precipitation of zeolites or DSPs is unlikely to occur. In this regard, the present inventors have found that at leaching temperatures of from 50° C. to 70° C., and for a time of from 10 minutes to 30 minutes results in good dissolution of the aluminium and silica components and little to no formation of precipitated zeolites or DSPs. In general terms, using a leaching temperature in the lower part of the range will allow use of longer leaching times, whilst using a leaching temperature in the higher part of the range will call for use of shorter leaching times.

The inventors have also found that impurities such as quartz, muscovite and feldspar do not dissolve in the leaching step but rather remain as solid particulates mixed with the leaching solution. As these materials will represent impurities if they become incorporated into the zeolite product, the mixture of pregnant leaching solution and solid residue is subjected to a solid/liquid separation step to separate the undissolved solid residue from the pregnant leaching solution. Any suitable solid/liquid separation technique may be used. Filtration is but one example. Other possible solid/liquid separation steps that may be used include sedimentation, decanting, centrifugation, cyclone separation, hydrocyclone separation, and the like. The skilled person will understand that there are many different solid/liquid separation processes or techniques that can be used in this step.

The solid/liquid separation step results in a purified pregnant leach solution being obtained. The solid residue that is separated from the pregnant leach solution may be discarded or it may be subjected to a second leaching step in order to extract further aluminium and silicate components therefrom, or subject to further treatment. For example, if the clay material comprises bauxite, the solid residue from the leaching step will comprise bauxite having a lower silica content and it may be sent to a Bayer process plant/alumina refinery for recovery of alumina therefrom. In other embodiments, the solid residue may be used as building products, road base or as a feed to a fertiliser plant.

The purified pregnant leach solution is then used to form zeolites. The purified pregnant leach solution contains dissolved aluminium and dissolved silicates. The pregnant leach solution has an alkaline pH, so the dissolved aluminium is likely to be present as aluminate and the dissolved silica species are likely to be present as silicate. This solution may be treated using conventional techniques to form zeolites.

In some embodiments, additional material can be added to the pregnant leach solution to change the ratio of Al to Si in the pregnant leach solution. For example, silica gel can be added to increase the amount of Si in the solution. Adjusting the ratio of Al to Si in the pregnant leach solution can provide some control over the zeolite product being formed, for example, Zeolite X, A Sodalite, etc. Changing of the processing conditions in the crystallisation stage can also provide some control over the product being made. It is noted that the prior art methods described in this specification did not allow for silica gel to be added (except when NaOH was being added) because the silica gel was difficult or impossible to disperse.

In one embodiment, the pregnant leach solution is heated to a temperature of from 80° C. to 100° C. and stirred in order to cause precipitation of zeolites. In one embodiment, the pregnant leach solution is heated to a temperature of about 90° C. and stirred in order to cause precipitation of zeolites. Stirring is used to keep the zeolite particles suspended in the solution and to prevent agglomeration of the particles into overly large particles.

A residence time of between 30 minutes and 10 hours, or between 1 hour and 5 hours, or between 1 hour and 4 hours, may be used in the crystallisation step.

It may also be possible to add templating agents, such as organic templating agents, seed particles and/or other additives such as are commonly used in conventional zeolite production in the zeolite crystallisation step of the present invention.

Once the zeolite particles have been formed, they will normally be separated from the solution, washed and dried. The zeolites may also be calcined, for example, to remove any organic templating agents.

The solution that is separated from the zeolite may be returned or recycled to the leaching step, or it may be used to conduct a second leaching step on the solid residue removed from the initial leaching step. In some embodiments, make up leach solution is added to the solution recovered from the crystallisation step. It may also be necessary to bleed off some of the leach solution to prevent impurities from building up in the recycled solution.

Embodiments of the method of the first aspect of the present invention enable zeolites to be formed from an inexpensive starting material and an impure starting material. The zeolites can have high purity, due to removal of the impurity components following the leaching step but before the zeolite crystallisation step. By avoiding precipitation of zeolites or DSPs during the leaching step, losses of yield are minimised. The solution recovered from the zeolite crystallisation step may be recycled to the leaching step or to a second leaching step, thereby further improving the economics of the process.

In a second aspect, the present invention provides a method for controlling a calcination step comprising the steps of calcining a material at elevated temperature and monitoring a phase or phases of the material being calcined during calcination using in-situ high temperature XRD, determining when a desired phase transformation in the material has been completed and either reducing heating in the furnace or removing the material from the furnace once the desired phase transformation in the material has been completed.

In one embodiment of the second aspect of the present invention, the method further comprises controlling temperature of the furnace to increase a temperature of the furnace if a phase transformation in the material is not occurring or is occurring at a rate determined to be too slow.

The method of the second aspect of the present invention may be used to control the calcination of a clay material as part of the method for producing zeolites in accordance with the first aspect of the present invention. The method of the second aspect of the present invention may also be used to control calcination of other materials in which the calcination is used to effect a phase transformation in the material.

Use of in-situ high temperature XRD allows the phase or phases of the material that are present during the calcination step to be closely monitored. When the in-situ high temperature XRD indicates that a desired phase transformation has completely occurred, the material may be removed from the furnace or the heating may be turned down in the furnace in order to minimise heating costs during the calcination step.

The method of the second aspect of the present invention provides for significantly more accurate determination of both the time and the temperature required to affect a desired phase transformation during calcination. Therefore, much more effective control of the calcination step can be achieved, which can enhance the economics of the calcination process.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 is a flow sheet of a prior art process for synthesising zeolites from kaolin minerals;

FIG. 2 is a flow sheet of a process for synthesising zeolites from kaolin minerals in accordance with an embodiment of the present invention;

FIG. 3 shows in-situ XRD patterns of heat-treated kaolinite from 550° C. to 675° C.;

FIG. 4 shows SEM images of (a) kaolin sample and (b) meta-kaolin after heat treatment at 650° C.;

FIG. 5 shows graphs of aqueous silicate concentration against time during kaolin leaching (FIG. 5a) and metakaolin leaching (FIG. 5b);

FIG. 6 shows XRD patterns for amorphous phase and zeolite LTA using kaolin sample heating at 650° C.;

FIG. 7 shows SEM images of (a) amorphous zeolite, (b) zeolite LTA, cubic, Pm3m and (c) sodalite, wool ball shaped particles, P43n;

FIG. 8 shows in-situ XRD patterns of heat-treated feed material in Example 2;

FIG. 9 shows XRD patterns for the zeolite containing product formed in example 2. FIG. 9 also shows XRD patterns for the zeolite containing product formed in accordance with prior art methods, as described in this specification;

FIG. 10 shows XRD patterns for the zeolite LTA formed in example 2;

FIG. 11 shows XRD patterns for the Kaolinite feed and the calcined feed material in example 3;

FIG. 12 shows XRD patterns for the zeolite containing product formed in example 3;

FIG. 13 shows XRD patterns for the bauxite feed and the calcined feed material in example 4;

FIG. 14 shows XRD patterns for the zeolite containing product formed in example 4;

FIG. 15 shows XRD patterns for the coal flotation tailings feed and the calcined feed material in example 5;

FIG. 16 shows XRD patterns for the zeolite containing product formed in example 5; and

FIGS. 17 to 20 show SEM photomicrographs of the zeolite products obtained in examples 2, 3, 4 and 5, respectively.

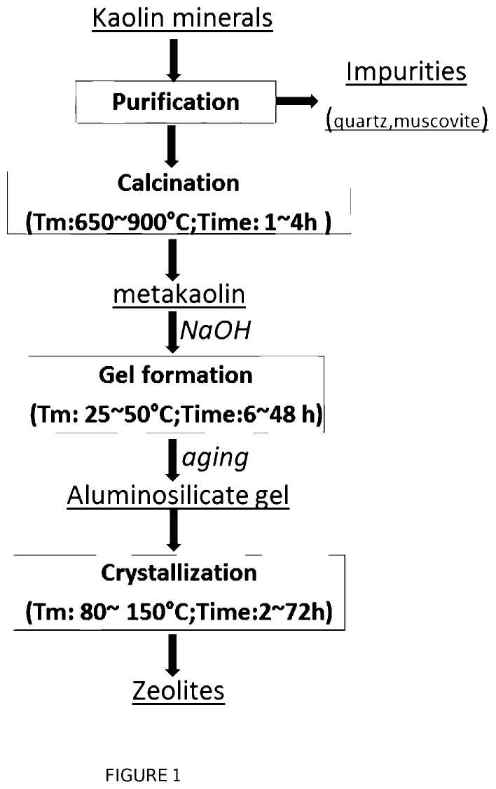

### DESCRIPTION OF EMBODIMENTS

It will be appreciated that the following examples have been provided for the purposes of illustrating preferred embodiments of the present invention. Therefore, the skilled person will understand that the present invention should not be considered to be limited solely to the features as described in the examples.

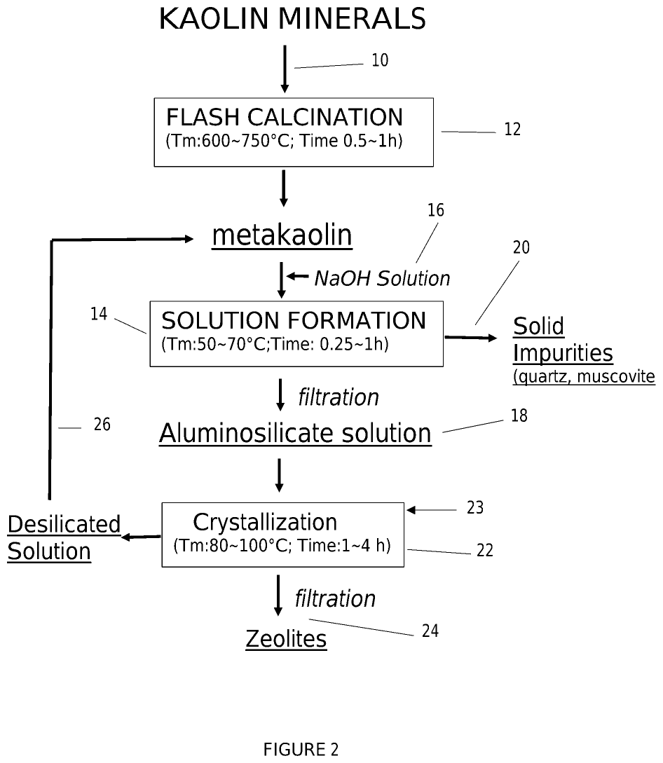

FIG. 2 shows a flow sheet of a process for synthesising zeolites from clay minerals in accordance with one embodiment of the present invention. In the flowsheet of FIG. 2, kaolin minerals 10 are fed to a calcination step 12 that is conducted in a furnace. The furnace is operated at a temperature of from 600° C. to 750° C. and the kaolin minerals are held in the furnace for a period of from 30 minutes to 1 hour. This converts the kaolinite to meta-kaolin. The meta-kaolin is fed to a leaching step 14 where is mixed with a 4M sodium hydroxide solution 16. In the leaching step 14, the aluminium and silicon components in the metakaolin are dissolved into solution to form an aluminosilicate solution (which is likely to consist of aluminates and silicates in solution). Impurities such as quartz, muscovite and feldspar do not dissolve in the leaching step 14. A solid/liquid separation step 15, such as filtration, is used to separate the pregnant leach liquor 18 from the solid impurities 20.

The pregnant leach liquor 20 is then treated in a crystallisation step 22 to form zeolites. The crystallisation step 22 is conducted at a temperature of from 80 to 100° C. and for a time of 1 to 4 hours, with stirring, to cause precipitation of the zeolites. Other components that may be used in zeolite crystallisation, such as templating agents, seed particles, and the like, may also be added to the crystallisation step 22. Additional material 23 may be added to change the ratio of Al to Si. For example, silica gel may be added. The zeolite particles are then separated from the liquid phase and the zeolite particles are recovered at 24. The zeolite particles may be washed and dried, as required and calcined to remove organic templating agents, if necessary. The desilicated solution 26 is recycled to the leaching step 14. In another embodiment, the solid impurities 20 may be mixed with the desilicated solution 26 to leach further aluminium and silicon components from the solid impurities. Where recycle of leach liquor takes place, it may be necessary to add make-up leach solution and to have a bleed stream from the recycle leach solution to prevent undesired build-up of impurities.

### Example 1

In this example, zeolites were synthesised in accordance with one embodiment of the present invention. Kaolinite (composition shown in Table 1), sodium hydroxide (2.2% Na₂CO₃ by weight) and aluminium hydroxide (99.4%) were sourced from Sigma-Aldrich. Lead nitrate (99%) and copper (II) nitrate (98%) from ThermoFisher Scientific and cobalt (II) chloride hexahydrate (98%) from Sigma-Aldrich.

TABLE 1
XRF Data of Kaolinite (wt. %)

| Samples | Al₂O₃ | SiO₂ | Fe₂O₃ | TiO₂ | MgO | Na₂O | LOI |
|---|---|---|---|---|---|---|---|
| Kaolin | 38.5 | 44.9 | 0.74 | 1.36 | 0.04 | 0.08 | 13.8 |

### Zeolite Synthesis

Kaolin (˜20 grams) was placed into a muffle furnace preheated to the target temperatures (650° C.) for 0.5 h to obtain the calcined product (amorphous meta-kaolin). Then, 2.5 g calcined products were added into a 250 ml glass beaker (with magnetic stirring) with 200 ml of 4 M NaOH solution which has been preheated to 60° C. The slurry was leached for 15 minutes or 30 minutes then filtrated at the same temperature. 0.2 ml filtrated liquid solution was sampled with dilution of 10 fold for ICP analysis. The filtrated liquid solution was transferred into a plastic bottle (250 ml) with two steel balls for mixing. The container was then placed into a water bath preheated to target temperature (90° C.) with an agitation speed of 500 rpm for 4 hour, which is enough time for full crystallisation and formation of the zeolite LTA. Based on the liquid solution chemical composition, extra gibbsite (Al(OH)₃) may need to be used to make up the Al/Si mole ratio up to 1. After crystallisation, the slurry was filtered. The solid sample was washed and dried in an oven overnight for the future adsorption test. The filtrate liquid solution was recycled to use the next round of kaolin leaching. 0.2 ml of filtrate liquid solution was sampled with 10× dilution for ICP analysis. Based on the liquid solution chemical composition, an extra amount of NaOH may need to be used to make up caustic solution up to 4M. For comparison, we also use kaolin or metakaolin feed samples to synthesis the sodalite (SOD) samples and amorphous zeolite samples.

### Sample Characterization

Rigaku Smartlab was used to perform the in-situ high temperature XRD analysis to determine the phase transformation of kaolin. The pulverized solid power was added in the small container made from corundum. The loaded container was placed on top of sampler holder and sealed by the dome. The heating rate was set to 50° C./minute. The holding time for each scan at each temperature was 10 minutes prior to the x-ray scan time which was approximately 15 minutes to cover the 2θ angle range of 5-40° using Cu Kα irradiation (λ=1.5406 Å) at 40 kV with a scanning speed of 0.05° per second.

The other crystalline solid phases were identified by X-ray diffraction (XRD) with a Bruker D8 Advance XRD with a LynxEye detector, and Cu Kα irradiation (λ=1.5406 Å) at 40 kV with a scanning speed of 0.050 per second over the 2θ angle range of 5−40°. The 2014 PDF database from BRUKER was used for reflection identification. The solid particle morphologies were observed by scanning electron microscopy (SEM, HITACHI SU3500) with an accelerating voltage of 5 kV and spot size of 30.

Characterisation of the solution samples was performed using Inductively Coupled Plasma Atomic Emission Spectrometry (ICP-AES).

### Results

### Thermal Activation of Kaolin

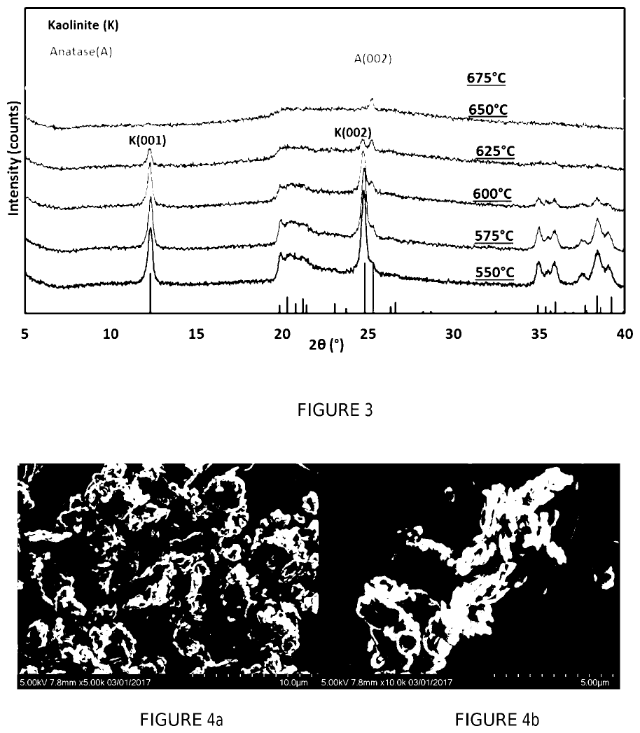

Accurately determining the kaolin to amorphous transition temperature is especially useful in the synthesis process in relation to energy costs. Most previous researchers utilise Thermo Gravimetric Analysis (TGA) to determine the phase transition temperature and time. Previously, most of the research implemented the thermo gravimetric (TG) method for estimation of weight loss of kaolin samples. Based on the chemical formula as shown in equation 3, the weight loss is around 14% if pure kaolin is fully de-hydroxylated. However, most kaolin samples contain impurities and the weight loss technique is not highly accurate. This causes the thermal activation normally reported to be over a wide temperate range from 550 to 1000° C., which typically overestimates the calcination time from 1 to 12 hours. Here, we implemented the methodology of in-situ high temperature XRD to monitor the phase transformation of kaolin with programmed heating rate (5˜200° C. per minute) and short scan time (5˜16 minutes). Instead of measuring the weight loss, the intensity change of key phase peaks at (001) and (002) planes of kaolin were recorded with different temperatures and heating times. The kaolin sample has no significant change under 500° C. As shown in FIG. 3, the sample at 550° C. still has the characteristic peaks of kaolinite and the impurity anatase (2Θ=25.33°). The intensity of the kaolinite crystal plane peaks decreases with increasing temperature. At 625° C., the peaks at range 20˜220 and 35˜40° for kaolin phase are not detectable while crystal plane peaks at (001) and (002) are still detectable. At 650° C., the XRD patterns only show the anatase peaks. This indicates that the kaolinite was fully dehydroxylated into x-ray amorphous phase. The dehydroxylation to the amorphous phase that occurs in the temperature range of 600-675° C. is shown in Equation 3.

Al₂[Si₂O₅](OH)₄→Al₂O₃.2SiO₂+2H₂O (3)

SEM images indicate that meta-kaolin started to lose the edge sheet structure of the kaolin as shown in FIG. 4 but still have the layer structure of crystals which is indicative of lack of long range crystalline structure.

### Hydrothermal Synthesis of Zeolites

In the synthesis process used in this example, kaolinite or metakaolin dissolves into highly alkaline solution then re-precipitates as insoluble sodium aluminate silicates known as zeolites based on equation 1 and 2.

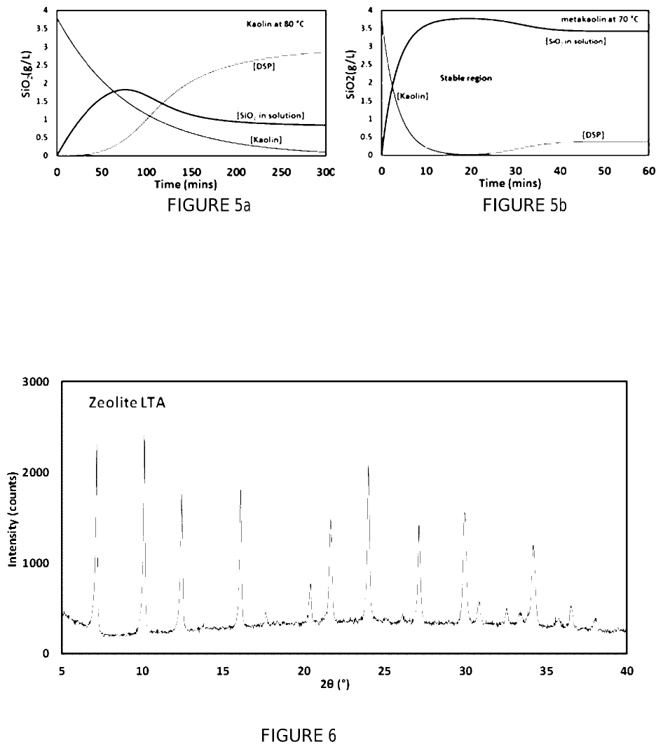

FIG. 5a shows leaching/dissolution of a kaolin feed material with a 4M NaOH solution. A can be seen from FIG. 5, the kaolin dissolves quite slowly in the leaching solution. The silicate concentration in solution increases as the kaolin dissolves. However, desilication products (DSP) start to precipitate after about 50 minutes and this leads to the silicate concentration in solution decreasing due to precipitation of the DSP. In contrast, when metakaolin is sent to the leaching test, the metakaolin dissolves very quickly and almost complete dissolution is obtained after 10 to 15 minutes. DSP starts to precipitate after about 25 to 30 minutes, with a maximum concentration of silica in solution being obtained between 10 minutes and 30 minutes. Therefore, by leaching metakaolin at 70° C. for a period of from 10 minutes to 30 minutes, loss of silicates to DSP in the leaching step can be avoided. It will be appreciated that any DSP that precipitates in the leaching step will precipitate onto the solid impurities that do not dissolve in the leaching solution. As it is necessary to separate the undissolved solid impurities from the leaching solution prior to zeolite crystallisation in order to obtain pure zeolite, the DSP that precipitates in the leaching step will precipitate onto the solid impurity particles and this will represent a loss of yield. In FIG. 5, the silicate concentration in solution (expressed as g/L SiO₂) is monitored and the kaolin and DSP are calculated from a mass balance.

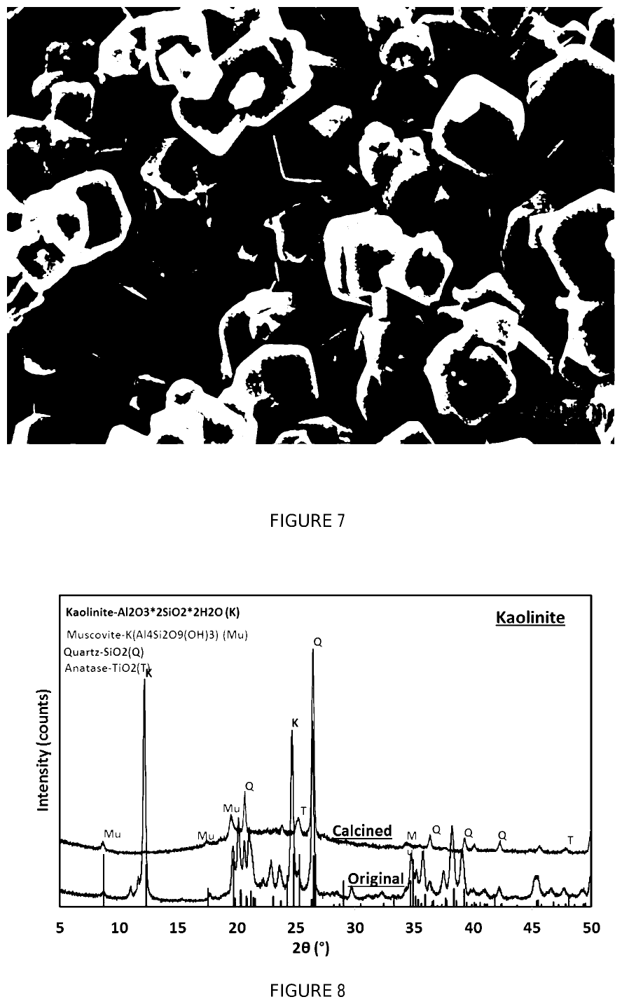

For zeolites made from a feed material in which the solid samples were heated at 650° C., as shown in FIG. 6, zeolite LTA is the only phase. The SEM image reveal the cubic structure of zeolite LTA shape as shown in FIG. 7.

### Example 2

A material having the composition as set out in Table 2 was used as the feed material in this example.

TABLE 2
XRF data of main chemical composition and
loss on ignition of feed samples(%)

| Al₂O₃ | TiO₂ | Fe₂O₃ | K₂O | SiO₂ | LOI |
|---|---|---|---|---|---|
| 32.9 | 1.0 | 1.3 | 0.9 | 51.1 | 13.0 |

The feed material was subjected to the following processing:

### Thermal Activation Stage:

25 gram samples were placed in ceramic containers and transferred into a muffle furnace, followed by preheating them to the target temperature of 750° C. for 1.5 h. FIG. 8 shows XRD patterns for the feed material and the calcined feed material.

### Leaching and Aging Stage:

The synthetic caustic liquor (50 mL) with caustic concentration 4M was magnetically stirred at 300-500 rpm in a 150 mL Erlenmeyer flask and sealed with Parafilm to prevent excessive liquid loss from evaporation. The solution was heated by a hotplate with a feedback controller. When the set-point temperature at 60° C. was reached, the activated solid samples (1.5 g) were added to the heated solution. Once the leaching reaction was completed in 1 hour, solids and liquids were separated through vacuum filtration. The filtrate solution will be used for the precipitation of the Zeolite 4A product.

### Crystallization Stage:

The obtained solution from the leaching test was transferred into 100 or 200 ml Teflon bottle or steel container. To synthesis different types of zeolites, extra silica or aluminium source will be added into solution to balance molar ratio of SiO₂/Al₂O₃. Then, the bottle was placed in the water bath with temperature of 90° C. for 2˜4 hours. The solid was filtrated and washed with DI water until pH value <9. The solid product was dried in an oven at 105° C. for 2˜4 hours.

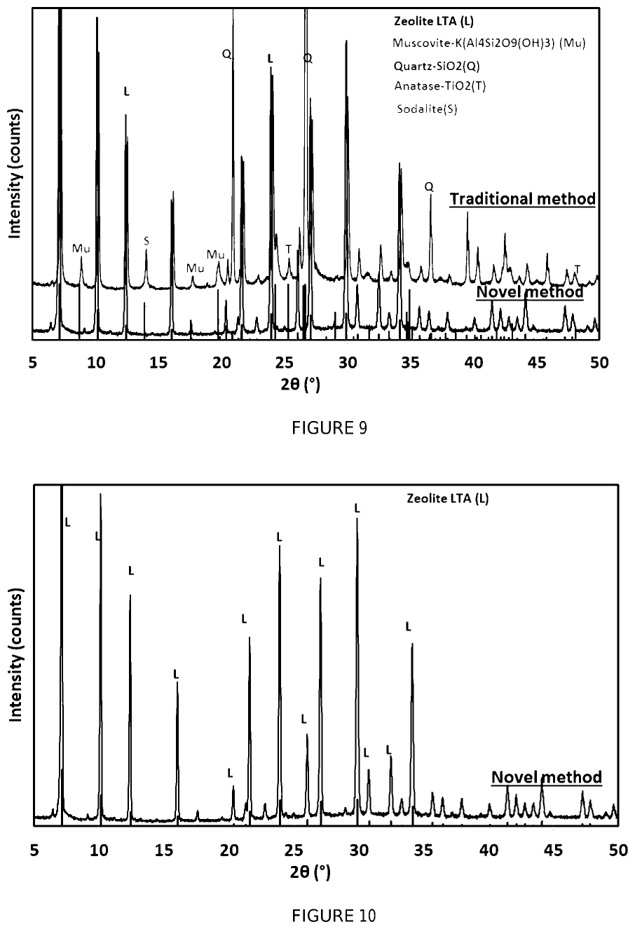

FIG. 9 shows XRD patterns for the zeolite containing product formed in example 2. FIG. 9 also shows XRD patterns for the zeolite containing product formed in accordance with prior art methods, as described in this specification. As can be seen from FIG. 9, the zeolite containing product formed in accordance with an embodiment of the present invention has much lower levels of other components than the zeolite containing product formed in accordance with prior art methods. FIG. 10 shows XRD patterns for the zeolite LTA formed in example 2

### Example 3

A material having the composition as set out in Table 2 was used as the feed material in this example.

TABLE 2
XRF data of main chemical composition and
loss on ignition of feed samples(%)

| Al₂O₃ | TiO₂ | Fe₂O₃ | K₂O | SiO₂ | LOI |
|---|---|---|---|---|---|
| 37.0 | 1.3 | 1.8 | 0.9 | 45.3 | 13.6 |

The feed material was subjected to the following processing:

### Thermal Activation Stage:

5 gram samples were placed in ceramic containers and transferred into a muffle furnace, followed by preheating them to the target temperature of 650° C. for 1 h.

### Leaching and Aging Stage:

The synthetic caustic liquor (50 mL) with caustic concentration 4M was magnetically stirred at 300-500 rpm in a 150 mL Erlenmeyer flask and sealed with Parafilm to prevent excessive liquid loss from evaporation. The solution was heated by a hotplate with a feedback controller. When the set-point temperature at 70° C. was reached, the activated solid samples (1 g) were added to the heated solution. Once the leaching reaction was completed in 0.5 hour, solids and liquids were separated through vacuum filtration. The filtrate solution will be used for the precipitation of the zeolite 4A product.

### Crystallization Stage:

The obtained solution from leaching test was transferred into 100 or 200 ml Teflon bottle or steel container. To synthesis different types of zeolites, the extra silica or aluminium source will be added into solution to balance molar ratio of SiO₂/Al₂O₃. Then, the bottle was placed in the water bath with temperature of 90° C. for 2 hours. The solid was filtrated and washed with DI water until pH value <9. The solid product was dried in an oven at 105° C. for 2˜4 hours.

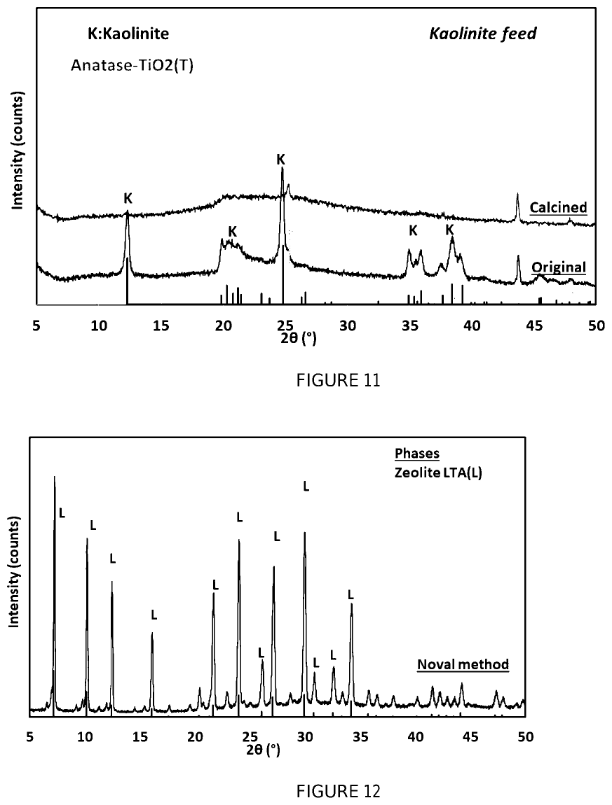

FIG. 11 shows XRD patterns for the kaolinite feed material and the calcined kaolinite. FIG. 12 shows XRD patterns of the zeolite formed in this example. The zeolite is predominantly zeolite LTA.

### Example 4

This example uses a high silica bauxite as a feed material. The high silica bauxite had a composition as shown in Table 4:

TABLE 4
Composition of high silica bauxite material
used as feed in example 4:

| Al₂O₃ | TiO₂ | Fe₂O₃ | K₂O | SiO₂ | LOI |
|---|---|---|---|---|---|
| 39.3 | 1.9 | 24.7 | 0.1 | 14.2 | 19.8 |

The high silica bauxite feed comprised gibbsite, boehmite, haematite, kaolinite, quartz, anatase and organics. The feed material was subjected to the following processing:

### Thermal Activation Stage:

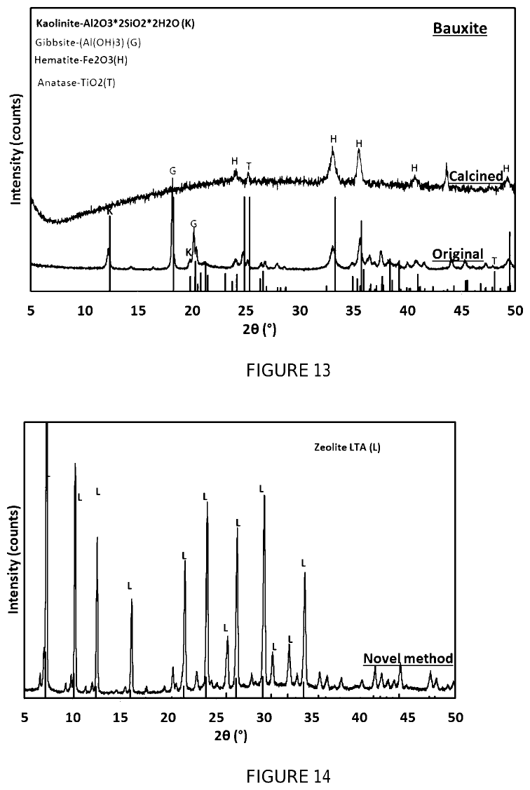

10 gram samples were placed in ceramic containers and transferred into a muffle furnace, followed by preheating them to the target temperature of 650° C. for 1 h. FIG. 13 shows XRD patterns for the bauxite feed material and the calcined bauxite feed material.

### Leaching and Aging Stage:

The synthetic caustic liquor (50 mL) with caustic concentration 4M was magnetically stirred at 300-500 rpm in a 150 mL Erlenmeyer flask and sealed with Parafilm to prevent excessive liquid loss from evaporation. The solution was heated by a hotplate with a feedback controller. When the set-point temperature at 60° C. was reached, the activated solid samples (2.5 g) were added to the heated solution. Once the leaching reaction was completed in 0.5 hour, solids and liquids were separated through vacuum filtration. The filtrate solution will be used for the precipitation of 4A product.

With this feed material, the solid impurities 20 resulting from the leaching step 14 shown in FIG. 2 comprise desilicated bauxite that can be fed to a Bayer process plant/alumina refinery. As the bauxite has had silica removed therefrom, some processing difficulties arising in the Bayer process plant/alumina refinery from having excess silica in the bauxite feed, such as excessive sodium hydroxide consumption and precipitation of desilication products on heat exchange surfaces causing fouling, can be reduced.

### Crystallization Stage:

The obtained solution from leaching test will be transferred into 100 or 200 ml Teflon bottle or steel container. To synthesis different types of zeolites, the extra silica or aluminium source will be added into solution to balance molar ratio of SiO₂/Al₂O₃. Then, the bottle was placed in the water bath with temperature of 90° C. for 2 hours. The solid was filtrated and washed with DI water until pH value <9. The solid product was dried in an oven at 105° C. for 2˜4 hours.

FIG. 14 shows XRD patterns of the zeolite formed in this example. The zeolite is predominantly zeolite LTA.

### Example 5

In this example, coal flotation tailings were used as a feed material. A full analysis of this feed material has not been completed but it is expected that it will contain around 20% Al₂O₃. The coal flotation tailings were treated with the following steps:

### Thermal Activation Stage:

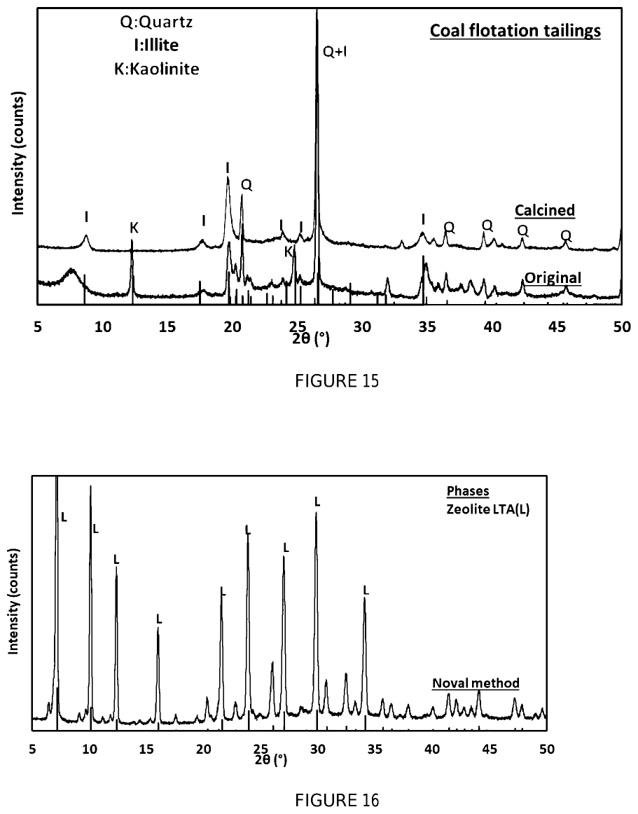

15 gram samples were placed in ceramic containers and transferred into a muffle furnace, followed by preheating them to the target temperature of 650° C. for 1 h. FIG. 15 shows the XRD patterns for the coal tailings feed product and the coal tailings after calcination.

### Leaching and Aging Stage:

The synthetic caustic liquor (50 mL) with caustic concentration 4M was magnetically stirred at 300-500 rpm in a 150 mL Erlenmeyer flask and sealed with Parafilm to prevent excessive liquid loss from evaporation. The solution was heated by a hotplate with a feedback controller. When the set-point temperature at 70° C. was reached, the activated solid samples (1.5 g) were added to the heated solution. Once the leaching reaction was completed in 0.5 hour, solids and liquids were separated through vacuum filtration. The filtrate solution will be used for the precipitation of product.

### Crystallization Stage:

The obtained solution from leaching test will be transferred into 100 or 200 ml Teflon bottle or steel container. To synthesis different types of zeolites, the extra silica or aluminium source will be added into solution to balance molar ratio of SiO₂/Al₂O₃. Then, the bottle was placed in the water bath with temperature of 90° C. for 2 hours. The solid was filtrated and washed with DI water until pH value <9. The solid product was dried in an oven at 105° C. for 2˜4 hours. FIG. 16 shows XRD patterns of the zeolite formed in this example. The zeolite is predominantly zeolite LTA.

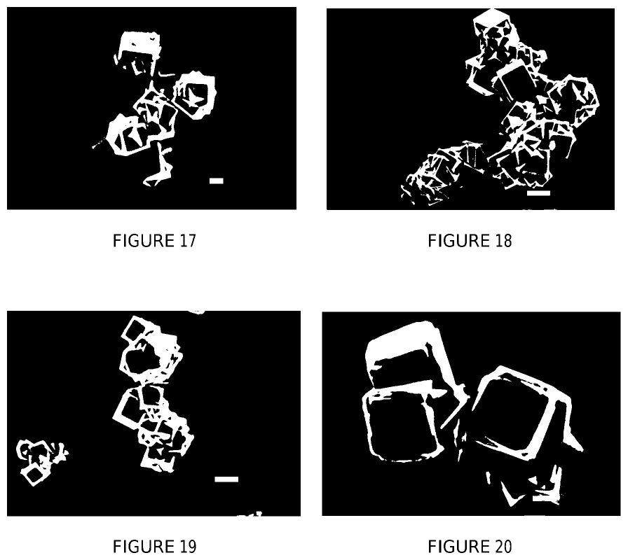

FIGS. 17 to 20 show SEM photomicrographs of the zeolite products obtained in examples 2, 3, 4 and 5, respectively.

Zeolites produced in accordance with the present invention can be used to remove heavy metals from solution. Indeed, the present inventors have conducted experimental test that show heavy metal ions, such as Cu, Pb and Co, can be removed from solution using zeolites produced in accordance with the present invention.

The zeolites produced in accordance with the present invention can also be used in any other applications in which the zeolites are known to be useful. Examples include gas separation, detergents, ethanol drying, water absorption and heavy metal absorption, and catalysis. The skilled person will understand that the final use for the zeolites produced in accordance with the present invention is not limited to any of the above-mentioned uses but can extend to any possible use for zeolites.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A process for producing zeolites, the process comprising:
a) calcining a clay material to form an amorphous material from clay components in the clay material;
b) leaching the amorphous material from step (a) in a leaching solution at 70° C. or less to produce a solution containing dissolved aluminium and dissolved silica and a solid residue;
c) separating the solid residue from the solution; and
d) crystallising zeolites from the solution from step (c).

2. The process as claimed in claim 1, wherein the clay material comprises kaolin clays, kaolinite (Al₄Si₄O₁₀(OH)₈), halloysite (Al₂Si₂O₅(OH)₄) and montmorillonite (Al₄(Si₄O₁₀)₂(OH)₄*xH₂O)), mining tailings, mining tailings from kaolin mining, coal gangue kaolin, bentonite clays and bauxite mine or flotation tailings, coal flotation tailings and bauxite.

3. The process as claimed in claim 1, wherein the calcination step includes characterising phase transformation of the clay material using in-situ high temperature XRD (x-ray diffraction) by subjecting one or more samples of clay material to programmed heating rate and time and using in-situ XRD to obtain the XRD phase transformation pattern of the clay material and determining optimum calcination temperature and calcination time.

4. The process as claimed in claim 1, wherein the calcination step involves calcining the clay material to a pre-determined temperature for a pre-determined period of time.

5. The process as claimed in claim 1, wherein the temperatures used in the calcination step is between 600° C. to 900° C. or from 625° C. to 800° C., or from 650° C. to 750° C.

6. The process as claimed in claim 1, wherein the clay material is subject to heating in the calcination step for a period of from 1 minute to 2 hours, or from 5 minutes to 1.5 hours, or from 8 minutes to 1.5 hours.

7. The process as claimed in claim 1, wherein a kaolin clay material is used in the calcination step and kaolinite is converted to metakaolin in the calcination step.

8. The process as claimed in claim 1, wherein impurity quartz, muscovite and feldspar remain essentially unchanged in the calcination step.

9. The process as claimed in claim 1, wherein in the leaching step, the amorphous material recovered from the calcination step is leached in a leaching solution to dissolve the aluminium components and the silicate components from the amorphous material and whereby impurity components that were present in the material from step (a) do not dissolve and remain as a solid residue.

10. The process as claimed in claim 1, wherein the leaching solution comprises an alkaline solution.

11. The process as claimed in claim 10, wherein the alkaline solution suitably sodium hydroxide solution or potassium hydroxide solution.

12. The process as claimed in claim 1, wherein the alkaline solution comprises a hydroxide solution having a molar content of hydroxide ions of at least 1M, or from 1M to 6M, or from 1M to 5M, or from 1M to 4M or from 2M to 6M.

13. The process as claimed in claim 1, wherein the leaching step is conducted at a temperature at which precipitation of crystallisation of zeolites or other desilication products (DSPs) is suppressed or minimised.

14. The process as claimed in claim 1, wherein the temperature used in the leaching step from 50° C. to 70° C.

15. The process as claimed in claim 1, wherein impurities, including quartz, muscovite and feldspar, do not dissolve in the leaching step but remain as solid particulates mixed with the leaching solution and the mixture of pregnant leaching solution and solid residue is subjected to a solid/liquid separation step to separate the undissolved solid residue from the pregnant leaching solution.

16. The process as claimed in claim 1, wherein the solid/liquid separation step results in a purified pregnant leach solution being obtained and the solid residue that is separated from the pregnant leach solution is discarded or subjected to a second leaching step in order to extract further aluminium and silicate components therefrom, or subject to further treatment.

17. The process as claimed in claim 1, wherein the solution from step (c) comprises a purified pregnant leach solution that contains dissolved aluminium and dissolved silicates.

18. The process as claimed in claim 17, wherein additional material is added to the pregnant leach solution to change the ratio of Al to Si in the pregnant leach solution.

19. The process as claimed in claim 18, wherein silica gel is added to increase the amount of Si in the pregnant leach solution

20. The process as claimed in claim 17, wherein the pregnant leach solution is heated to a temperature of from 80° C. to 100° C., or about 90° C., and stirred in order to cause precipitation of zeolites.

21. The process as claimed in claim 20, wherein stirring is used to keep the zeolite particles suspended in the solution and to prevent agglomeration of the particles into overly large particles.

22. The process as claimed in claim 1, wherein a residence time of between 30 minutes and 10 hours, or between 1 hour and 5 hours, or between 1 hour and 4 hours, used in step (d).

23. The process as claimed in claim 1, wherein zeolite particles formed in step (d) are separated from the solution, washed and dried and optionally calcined.

24. The process as claimed in claim 23, wherein the solution that is separated from the zeolite is returned or recycled to the leaching step, or it may be used to conduct a second leaching step on the solid residue removed from the initial leaching step.

25. The process as claimed in claim 24, wherein make up leach solution is added to the solution recovered from the crystallisation step and/or some of the leach solution is bled off to prevent impurities from building up in the recycled solution.

26. The process as claimed in claim 1, wherein the leaching step has a residence time of less than 1 hour.
